(19) United States
(12) Patent Application Publication
(10) Pub. No.: US 2003/0022584 A1
(43) Pub. Date: Jan. 30, 2003

(54) Resilient fluid management materials for personal care products

(76) Inventors: Margaret Gwyn Latimer, Alpharetta, GA (US); Roland Columbus Smith JR., Gainesville, GA (US)

Correspondence Address: KIMBERLY-CLARK WORLDWIDE, INC., 401 NORTH LAKE STREET, NEENAH, WI, 54956

(21) Appl. No.: 10/234,568

(22) Filed: Sep. 4, 2002

Related U.S. Application Data
(62) Division of application No. 09/652,607, filed on Aug. 30, 2000.
Application No. 09/652,607 is a division of application No. 09/212,797, filed on Dec. 16, 1998, now abandoned.

(51) Int. Cl. B32B 1/00; D06N 7/04

(52) U.S. Cl. 442/414; 428/141; 428/152

(57) ABSTRACT

There is provided a corrugated nonwoven web where at least 40 percent of the web surface area is made from fusible fibers. The corrugated web is bonded such that no gaps are present between the folds of the web. Such webs provide comparable compression resistance and resiliency to, and greater void volume than, webs having a conventional X-Y plane fiber alignment.

There is further provided personal care products having the corrugated nonwoven web as a component where the web is placed in the product in the transverse direction.

### FIELD OF THE INVENTION

The present invention relates to a structure in an article for personal care like diapers, training pants, absorbent underpants, adult incontinence products, bandages and feminine hygiene products, which can accept liquid and which are resilient in maintaining their shape under compression.

### BACKGROUND OF THE INVENTION

Personal care articles include such items as diapers, training pants, feminine hygiene products such as sanitary napkins, panty-liners and tampons, incontinence garments and devices, bandages and the like. The most basic design of all such articles typically includes a bodyside liner, an outercover and an absorbent core disposed between the bodyside liner and the outercover.

Personal care products must accept fluids quickly and without collapsing under the pressure of the users body or of the liquid. The product must be flexible and have a pleasing feel on the skin. Unfortunately, while previous products have met many of these criteria, a number have not.

The expansion of layers containing superabsorbents upon exposure to bodily fluids, for example, has been known to block further acceptance of liquid, a phenomenon known as “wet collapse”. Wet collapse eliminates void space for fluid to enter and can render the absorbent core ineffective.

Many materials are unable to stand up to compressive forces applied laterally, such as that applied by the user's legs in diapers and sanitary napkins, for example. This mechanical action can result in a product's absorbent core collapsing, bunching or roping between the user's legs. This collapse of the core leads to a loss of the void volume intended to be available to receive and store bodily fluids. This bunching also results in decreased absorbent area and absorbent protection for the user. Finally, this bunched and collapsed absorbent core is uncomfortable for the user. In order to achieve greater integrity and resilience, a variety of product construction methods and materials have been tried. These have included gluing absorbent core layers together, embossing the absorbent core layers, adding reinforcing materials to the absorbent core and adding a resilient element of the absorbent core to hold the structure open and retain void space.

Each of these approaches has resulted in some compromise in the absorbent and/or comfort features of the product. Glues and adhesives, for example, tend to be hydrophobic and so interfere with the absorption of bodily fluids into the product.

Embossing increases the integrity of the absorbent core by increasing its density but in so doing reduces the void volume needed for fluid intake and retention. The addition of reinforcing and resilient materials likewise has proven unsatisfactory.

There remains a need, therefore, for a material which will remain flexible and soft while resisting compressive forces and so maintaining its void volume to accept subsequent fluid flows.

It is an object of this invention, therefore, to provide an absorbent structure which can accept fluids while maintaining its void volume and resisting compressive forces, while also being soft and flexible.

### SUMMARY OF THE INVENTION

The objects of the invention are achieved by a corrugated nonwoven web where at least 40 percent of the web surface area is made from fusible fibers. The corrugated web is bonded such that no gaps are present between the folds of the web. Such webs provide comparable compression resistance and resiliency and greater void volume than webs having a conventional X-Y plane fiber alignment. A variety of methods may be used to make such webs, including spunbonding, bonding and carding, airlaying, etc. The web is then corrugated and thermally bonded to yield a web with perpendicular or Z-direction orientation of fibers and which has no gaps, channels or valleys between the folds of the web.

There is further provided personal care products having the corrugated nonwoven web as a component where the web is placed in the product in such that the transverse direction of the web is parallel to the transverse direction of the product.

### BRIEF DESCRIPTION OF THE DRAWINGS

FIG. 1 is a diagram of a vibrating lapper used to produce webs having perpendicularly laid (Z-directional) fibers.

FIG. 2 is a diagram of a rotary lapper used to produce webs having perpendicularly laid (Z-directional) fibers.

FIG. 3 shows a folded (corrugated) fiber batt 2 and indicates the X 12, Y 13 and Z 14 axes.

FIG. 4 shows a folded fiber batt 2 with non-uniform fold heights.

FIG. 5 shows a laminate 15 comprising a folded fiber batt 2 and another fabric, foam or other material 16 beneath.

FIG. 6 shows a cross sectional view of a laminate 15 comprising a folded fiber batt 2 with non-uniform heights and another fabric, foam or other material 16 beneath.

FIG. 7 shows the preferred orientation of a folded fiber batt 2 in a personal care product which is, in this case, a diaper 30.

FIG. 8 shows a holder 27 used in the compression resistance test procedure.

FIG. 9 shows a corrugated web having gaps between the folds.

FIG. 10 shows a corrugated web without gaps between the folds.

### DEFINITIONS

“Disposable” includes being disposed of after use and not intended to be washed and reused.

“Front” and “back” are used throughout this description to designate relationships relative to the garment itself, rather than to suggest any position the garment assumes when it is positioned on a wearer.

“Hydrophilic” describes fibers or the surfaces of fibers which are wetted by the aqueous liquids in contact with the fibers. The degree of wetting of the materials can, in turn, be described in terms of the contact angles and the surface tensions of the liquids and materials involved. Equipment and techniques suitable for measuring the wettability of particular fiber materials can be provided by a Cahn SFA-222 Surface Force Analyzer System, or a substantially equivalent system. When measured with this system, fibers having contact angles less than 90° are designated “wettable” or hydrophilic, while fibers having contact angles equal to or greater than to 90° are designated “nonwettable” or hydrophobic.

“Layer” when used in the singular can have the dual meaning of a single element or a plurality of elements.

“Liquid” means a non-particulate substance and/or material that flows and can assume the interior shape of a container into which it is poured or placed.

“Liquid communication” means that liquid is able to travel from one layer to another layer, or one location to another within a layer.

“Longitudinal” means having the longitudinal axis in the plane of the article and is generally parallel to a vertical plane that bisects a standing wearer into left and right body halves when the article is worn. The “transverse” axis lies in the plane of the article generally perpendicular to the longitudinal axis, i.e., so that a vertical plane bisects a standing wearer into front and back body halves when the article is worn.

“Conjugate fibers” refers to fibers which have been formed from at least two polymers extruded from separate extruders but spun together to form one fiber. Conjugate fibers are also sometimes referred to as multicomponent or bicomponent fibers. The polymers are usually different from each other though conjugate fibers may be monocomponent fibers. The polymers are arranged in substantially constantly positioned distinct zones across the cross-section of the conjugate fibers and extend continuously along the length of the conjugate fibers. The configuration of such a conjugate fiber may be, for example, a sheath/core arrangement wherein one polymer is surrounded by another or may be a side by side arrangement, a pie arrangement or an “islands-in-the-sea” arrangement. Conjugate fibers are taught in U.S. Pat. No. 5,108,820 to Kaneko et al., U.S. Pat. No. 5,336,552 to Strack et al., and U.S. Pat. No. 5,382,400 to Pike et al. For two component fibers, the polymers may be present in ratios of 75/25, 50/50, 25/75 or any other desired ratios. The fibers may also have shapes such as those described in U.S. Pat. Nos. 5,277,976 to Hogle et al., and 5,069,970 and 5,057,368 to Largman et al., hereby incorporated by reference in their entirety, which describe fibers with unconventional shapes.

“Biconstituent fibers” refers to fibers which have been formed from at least two polymers extruded from the same extruder as a blend. The term “blend” is defined below. Biconstituent fibers do not have the various polymer components arranged in relatively constantly positioned distinct zones across the cross-sectional area of the fiber and the various polymers are usually not continuous along the entire length of the fiber, instead usually forming fibrils or protofibrils which start and end at random. Biconstituent fibers are sometimes also referred to as multiconstituent fibers. Fibers of this general type are discussed in, for example, U.S. Pat. No. 5,108,827 to Gessner. Bicomponent and biconstituent fibers are also discussed in the textbook Polymer Blends and Composites by John A. Manson and Leslie H. Sperling, copyright 1976 by Plenum Press, a division of Plenum Publishing Corporation of New York, IBSN 0-306-30831-2, at pages 273 through 277.

As used herein, the term “machine direction” or MD means the length of a fabric in the direction in which it is produced. The term “cross machine direction” or CD means the width of fabric, i.e. a direction generally perpendicular to the MD.

As used herein the term “spunbonded fibers” refers to small diameter fibers which are formed by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, and U.S. Pat. No. 3,542,615 to Dobo et al. Spunbond fibers are generally not tacky when they are deposited onto a collecting surface. Spunbond fibers are generally continuous and have average diameters (from a sample of at least 10) larger than 7 microns, more particularly, between about 10 and 35 microns. The fibers may also have shapes such as those described in U.S. Pat. No. 5,277,976 to Hogle et al., U.S. Pat. Nos. 5,466,410 to Hills and 5,069,970 and 5,057,368 to Largman et al., which describe fibers with unconventional shapes.

As used herein the term “meltblown fibers” means fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin et al. Meltblown fibers are microfibers which may be continuous or discontinuous, are generally smaller than 10 microns in average diameter, and are generally tacky when deposited onto a collecting surface.

“Airlaying” is a well known process by which a fibrous nonwoven layer can be formed. In the airlaying process, bundles of small fibers having typical lengths ranging from about 3 to about 52 millimeters are separated and entrained in an air supply and then deposited onto a forming screen, usually with the assistance of a vacuum supply. The randomly deposited fibers then are bonded to one another using, for example, hot air or a spray adhesive. Airlaying is discussed in, for example, U.S. Pat. Nos. 4,005,957, 4,388,056, 4,592,708, 4,598,441, 4,674,996, 4,761,258, 4,764,325, 4,904,440, 4,908,175, and 5,004,579, German Patent DE3508344 A1, European Patent Application 85300626.0 and British Patent Application 2,191,793.

As used herein, the term “coform” means a process in which at least one meltblown diehead is arranged near a chute through which other materials are added to the web while it is forming. Such other materials may be pulp, superabsorbent or other particles, natural polymers (for example, rayon or cotton fibers) and/or synthetic polymers (for example, polypropylene or polyester) fibers, for example, where the fibers may be of staple length. Coform processes are shown in commonly assigned U.S. Pat. Nos. 4,818,464 to Lau and 4,100,324 to Anderson et al. Webs produced by the coform process are generally referred to as coform materials.

“Bonded carded web” refers webs are made from staple fibers which are sent through a combing or carding unit, which breaks apart and aligns the staple fibers in the machine direction to form a generally machine direction-oriented fibrous nonwoven web. The web is bonded by one or more of several known bonding methods.

Bonding of nonwoven webs may be achieved by a number of methods; powder bonding, wherein a powdered adhesive is distributed through the web and then activated, usually by heating the web and adhesive with hot air; pattern bonding, wherein heated calender rolls or ultrasonic bonding equipment are used to bond the fibers together, usually in a localized bond pattern, though the web can be bonded across its entire surface if so desired; through-air bonding, wherein air which is sufficiently hot to soften at least one component of the web is directed through the web; chemical bonding using, for example, latex adhesives which are deposited onto the web by, for example, spraying; and consolidation by mechanical methods such as needling and hydroentanglement.

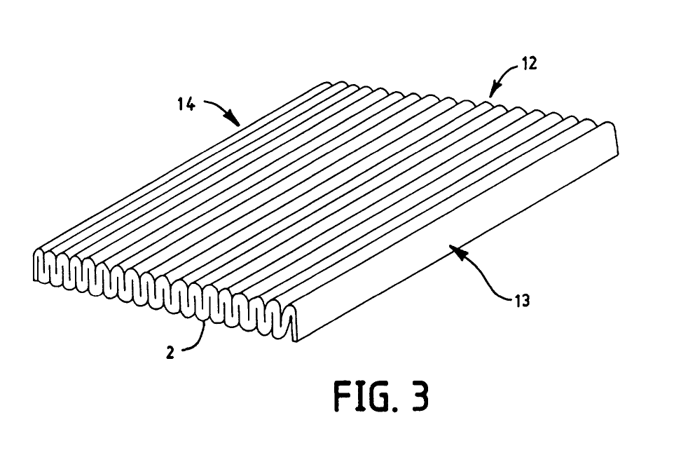

“Perpendicularly laid” or “Z-directional fabrics” are fabrics in which the fibers are oriented in a direction perpendicular to the predominant plane (X-Y) of the fabric. This predominant plane is also generally the MD-CD plane. FIG. 3 indicates the direction of the three axes.

“Personal care product” means diapers, training pants, absorbent underpants, adult incontinence products, swim wear, bandages and feminine hygiene products.

“Feminine hygiene products” means sanitary napkins, pads and tampons.

“Target area” refers to the area or position on a personal care product where an insult is normally delivered by a wearer.

### Test Methods

Material caliper (thickness): The caliper of a material is a measure of thickness and is measured at 0.05 psi with a Starret-type bulk tester, in units of millimeters.

Density: The density of the materials is calculated by dividing the weight per unit area of a sample in grams per square meter (gsm) by the bulk of the sample in millimeters (mm) at 68.9 Pascals and multiplying the result by 0.001 to convert the value to grams per cubic centimeter (g/cc). A total of three samples would be evaluated and averaged for the density values.

Compression Resistance Test:

Personal care articles typically encounter two major modes of compressive force. Side compressive force, for example, is exerted by the legs of the user, and “z” compressive forces are exerted due to the weight of the user or pressure exerted by clothing. Side compressive resilience is defined as the behavior of materials when force is applied normal to the y-z plane, commonly called x-dimension compression and z-direction compressive resilience is defined as behavior of materials when force is applied normal to the x-y plane, commonly understood as thickness or z-dimension compression. FIG. 3 illustrates the directions of these axes for a typical folded fiber batt 2, with the x axis being number 12, y axis being number 13 and z axis being number 14.

A single cycle compression test was used to characterize fabric resilience for each mode. The test apparatus used was a MTS Sintech/2 Model 3397-139 computerized material test system. The compression test procedure was defined and data generated using Testworks software system version 3.06.

X-Dimension Compression (Side Compression):

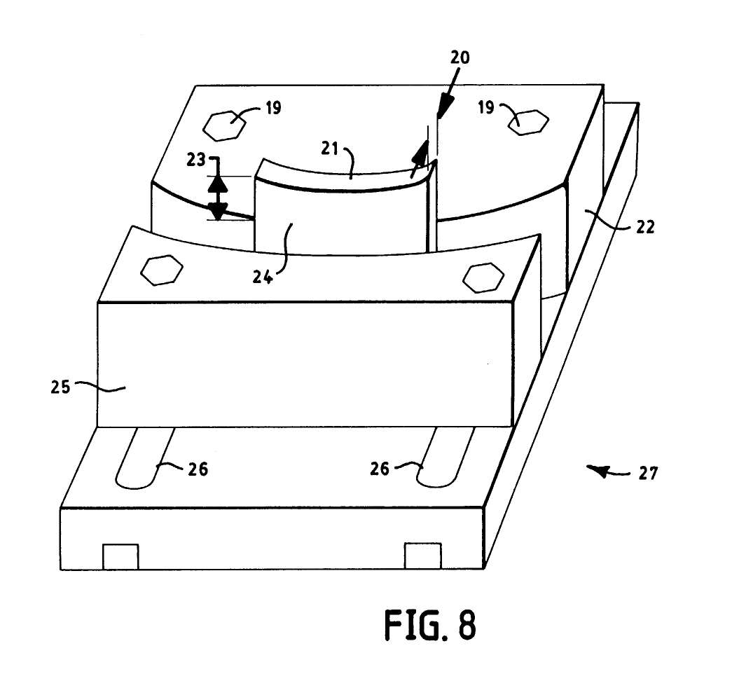

To measure x-dimension compressive resilience without introducing bending or buckling, a specific sample holder 27 was utilized. The sample holder 27 is shown in FIG. 8 and was designed to secure the sample 24 while exposing the y, z face 21 of the sample 24 at a defined height 23 above the surface of the holder 27. The sample 24 is placed in the holder 27 against the back brace 22 then the adjustable front brace 25 is moved into contact with the sample 24 by sliding it in grooves 26 and securing it with bolts 19. This arrangement allows for the sample 24 to be held upright. Slight curvature is placed in the sample 24 by the shape of the holder 27 to further minimize buckling and bending. The mounted sample 24 and holder 27 are placed in a compression testing machine (not shown) which may be, for example, an MTS Sintech machine. A compression testing machine typically has a platten which is moved downward into contact with the sample 24 on y, z face 21. The sample 24 is compressed to 50% of its initial height 23 above the holder 27 at a rate of 0.5 inches (1.27 cm) per minute. The maximum compression result for a given sample is achieved when the platten reaches its lowest point of travel. The load exerted to compress the sample 24 is recorded throughout the test. The area over which the load is applied is defined by the total sample 24 length and thickness 20 in the holder 27. Five replicates for each sample 24 were tested. Reference to FIG. 3 is helpful in understanding sample 24 size and application of the load for this test. Samples were cut to a size of 1.5 (3.8 cm) inches along the x axis 12 and 2 inches (5.1 cm) along the y axis 13. The height of the holder 27 braces (22, 25) is 1.22 inches (3.1 cm), allowing the exposed height 23 to be 0.28 inches (0.71 cm).

Sample Calculation:

A fabric sample is prepared to dimensions described above with a thickness of 0.5 inches. This sample is mounted into the holder as described to expose the y, z face to a load. The area over which the load is applied can be calculated as:

Area (A)=Thickness×length=0.5 inch×2.0 inch=1 square inch

If the load measured at maximum compression is determined to be 0.079 pounds, the force to compress can be calculated as:

Force (F)=Load/Area of application=0.079 pounds/1 in²=0.079 psi

In general, data generated during the load/unload sequence for compression tests may be charted to generate curves depicting sample thickness versus load. The area of these curves may then be thought of as a relative measure of compressive toughness. A comparison of the area under the load and unload curves may be calculated through integrative technique, determined manually by weighing cut out samples of the curves or by using software that is specifically designed for the tensile test machine. Regardless of technique, the ratio of the area under a load curve and the area under the unload curve for a given sample may be thought of as the “compressive toughness ratio”. Using this technique it is possible to compare structural behavior of various materials.

Z-Dimension Compression:

In order to characterize z-dimension compression resilience, no special holder was required. The sample was placed on a flat anvil surface which was secured to the bottom platform of a MTS Sintech machine. A platten is attached to the moveable upper crosshead and a load is applied as the platten is moved downward into contact with the fabric.

Pre-weighed, circular samples of test fabric measuring 2 inches in diameter were used. Load was applied in a direction that was parallel to the z direction of the sample The sample was compressed at a rate of 0.5 inches/min until the measured load was at 9.42 pounds which corresponds to 3 psi force on the 2 inch diameter sample. Data was gathered through this single cycle test as the sample was loaded and as the load was removed. Displacement at load points corresponding to applied forces of 0.05, 1, 2, 3, 2, 1 and 0.05 psi was noted during the load and unload sequence. From the data it is possible to generate load and unload curves for samples which define thickness of the material at any point through an entire compression cycle.

### DETAILED DESCRIPTION OF THE INVENTION

A personal care product typically has a body side layer, optionally a fluid transfer layer, a fluid retention layer and a garment side layer acting together as an absorbent system. It may also have a distribution layer or other optional layers to provide specialized functions. This absorbent system for a personal care product, is comprised of layers positioned between the body side and garment side layers, must take in and distribute fluid in a controlled manner away from contact with the body.

The body side layer is sometimes referred to as a bodyside liner or topsheet. In the thickness direction of the article, the liner material is the layer against the wearer's skin and so the first layer in contact with liquid or other exudate from the wearer. The liner further serves to isolate the wearer's skin from the liquids held in an absorbent structure and should be compliant, soft feeling and non-irritating. The body side liner can be surface treated with a selected amount of surfactant, or otherwise processed to impart the desired level of wettability and hydrophilicity.

The garment side liner layer, also referred to as a backsheet or outer cover is the farthest layer from the wearer. The outer cover has traditionally been formed of a thin thermoplastic film, such as polyolefin (e.g. polyethylene) film, which is substantially impermeable to liquid. The outer cover functions to prevent body exudates contained in an absorbent structure from wetting or soiling the wearer's clothing, bedding, or other materials contacting the personal care product. The outer cover may be, for example, a polyethylene film having an initial thickness of from about 0.5 mil (0.012 millimeter) to about 5.0 mil (0.12 millimeter) and a basis weight of from about 10 to about 100 gsm, or may comprise synthetic fibers and binder in a ratio of from about 50/50 to about 0/100.

The outer cover may be embossed and/or matte finished to provide a more aesthetically pleasing appearance. Other alternative constructions for outer cover include woven or nonwoven fibrous webs or laminates formed of a woven or nonwoven fabric and thermoplastic film. The outer cover may optionally be composed of a vapor or gas permeable, microporous “breathable” material, that is permeable to vapors or gas yet substantially impermeable to liquid. Outer covers may also serve the function of a mating member for mechanical fasteners.

The absorbent system layers located between the body side and garment side layers, must absorb liquid from the adjacent body side layer in a controlled manner such that liquid may be stored away from contact with the body. The inventors have found that corrugated nonwoven fabrics, used as the absorbent system in a personal care product such that the fibers of the corrugated nonwoven are oriented in the Z-direction, provide enhanced fluid intake. Such Z-directionally oriented fibers facilitate fluid movement away from the skin since fluid flows along the fiber surfaces. These corrugated nonwovens also provide increased void volume and partition the void volume in an effective manner so as to allow intake of greater volumes of liquid than convention, uncorrugated, fabrics. This increase in void volume is indicated by lower densities. Corrugating the fabric causes the material to act as a spring, opening and closing under load but generally returning to its original shape.

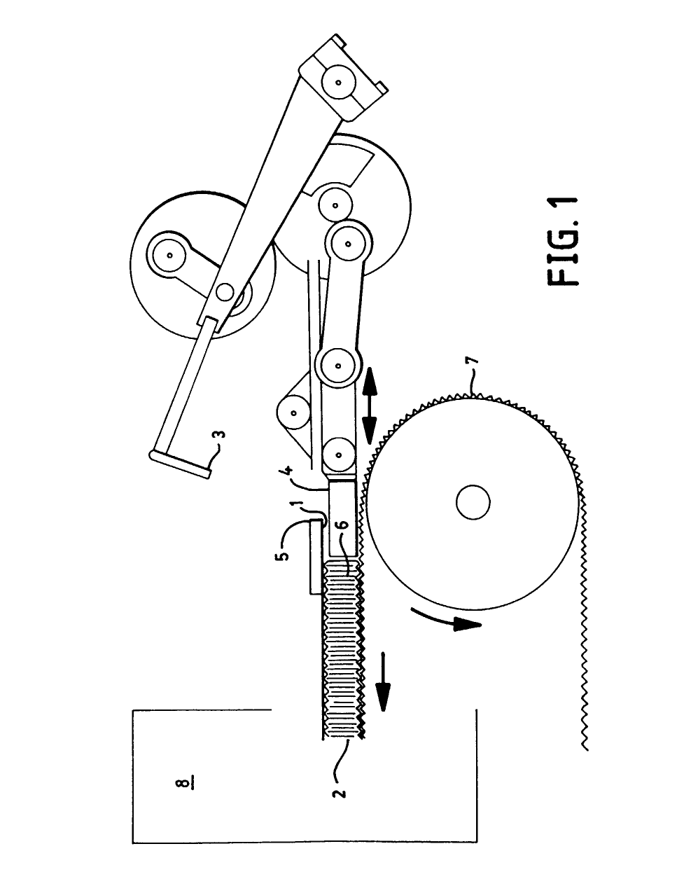

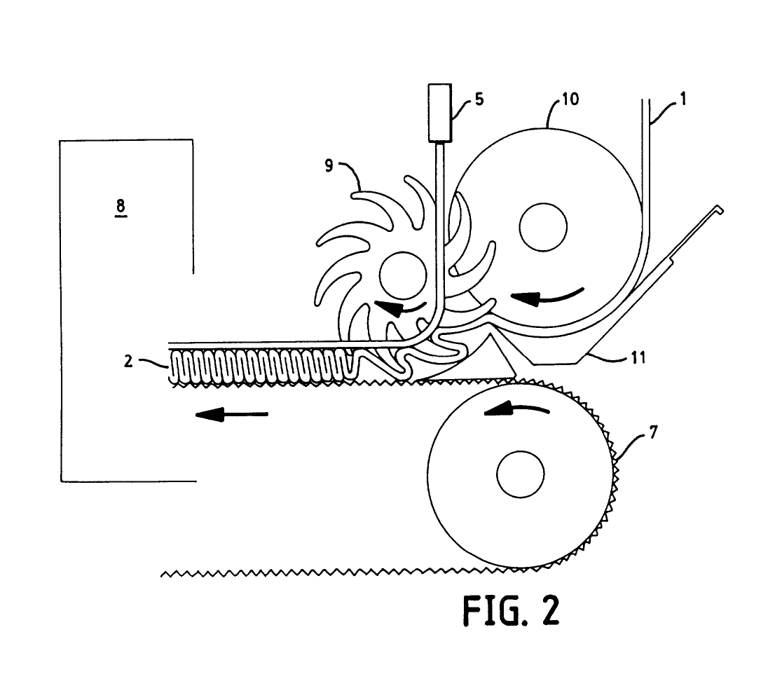

Corrugated fabrics have been known in the art and a number of examples of methods of making such fabrics may be found in, for example, U.S. Pat. Nos. 4,111,733, 5,167,740, 5,558,924 and 5,620,545, incorporated herein by reference. A particularly suitable method may be found in the October 1997 issue of Nonwovens Industry magazine at page 74 in an article by Krema, Jirsak, Hanus and Saunders entitled “What's New in Highloft Production?” as well as in Czech patents 235494 entitled “Fibre Layer, Method of its Production and Equipment for Application of Fibre Layer Production Method” issued May 15, 1995 and 263075 entitled “Method for Voluminous Bonded Textiles Production” issued Apr. 14, 1989. The vibrating lapper (FIG. 1) and the rotary lapper (FIG. 2) therein described are commercially available from Georgia Textile Machinery of Dalton, Ga., USA.

In FIG. 1, the vibrating lapper has a reciprocating comb 3 which pulls a carded web 1 along a guide board 6 towards the conveyor belt 7. A fold is formed in the carded web 1 and pulled off the comb 3 by a system of needles placed on a reciprocating compressing bar 4. The folded carded web 1 is pushed by the reciprocating compressing bar 4 to form a perpendicularly laid fiber batt 2, which is then moved forward between a conveyor belt 7 and a wire guide 5. The conveyor belt 7 brings the fiber batt 2 into a bonding device 8, which typically functions either thermally or mechanically.

The rotary lapper shown in FIG. 2 feeds the carded web 1 between a feeding disc 10 and a feeding pan 11 and into the working disc teeth 9. The folds are created in the carded web 1 as it passes between the teeth 9 producing a perpendicularly laid fiber batt 2, which is transported between a conveyor belt 7 and a wire guide 5 towards a bonding device 8.

The rotating lapper process and variants are further described in European patent application EP 0516964 B1 which teaches that fabrics so produced are useful primarily in the clothing industry as heat insulating lining materials, in the furniture industry as elastic fillers, in the automotive and construction industries as thermal and noise insulation, etc.

The use of perpendicularly laid fabrics, according to the definition above, has been known for production of carpet under pads, sleeping bag insulation and sound insulation where basis weights were considerably higher than that permissible for personal care products which must be lightweight and comfortable. Z-directional fabrics have been investigated previously for personal care products wherein the fibers provide superior fluid movement. U.S. Pat. Nos. 4,578,070 and 4,681,577 for example, teach aligning the corrugations parallel to the longitudinal axis of a personal care product. U.S. Pat. No. 4,886,511 teaches the use of elasticized strands across the crotch of a diaper so as to corrugate the product. EP 0767649 A1 describes a pleated front covering layer for a sanitary napkin with longitudinal channels on the surface. U.S. Pat. No. 5,695,487 teaches the use of meltblown webs for such fabrics wherein the fibers were aligned in the longitudinal direction. Recognized in the instant invention has been the contribution of perpendicularly orientated fibers to fluid intake as well as the contribution to compression resistance and, therefore, product integrity, of transversely orienting such fabrics in a personal care product. The low density perpendicularly oriented fabrics used in the practice of this invention have a higher void volume when compared to conventional X-Y oriented fabrics. The perpendicular orientation of the fibers also results in comparable mechanical compression resilience. The inventors have found that placing the perpendicularly oriented fabrics into a personal care product such that the cross machine direction of the fabric is in the longitudinal direction provides the greatest degree of side compression resistance. The webs which may be subjected to the perpendicular orientation process may be produced by a variety of process including airlaying, bonded carded web processes, spunbonding, meltblowing and coform processes. The webs may be made from a variety of fibers and mixtures of fibers including synthetic fibers, natural fibers and binders. The fibers in such a web may be made from the same or varying diameter fibers and may be of different shapes such as pentalobal, trilobal, elliptical, round, etc. The web may also include particles, flakes or spheres to impart additional properties to the corrugated absorbent system.

Preferred fibers for inclusion are those having a relatively low melting point such as polyolefin fibers. Lower melting polymers provide the ability to bond the fabric together at fiber cross over points upon the application of heat. By “lower melting polymers” what is meant are those having a glass transition temperature less than about 175° C. In addition, fibers having as at least one component a lower melting polymer, like conjugate and biconstituent fibers, are suitable for the practice of this invention. Any fiber having a lower melting polymer will hereinafter be referred to as “fusible fibers”.

Synthetic fibers include those made from polyamides, polyesters, rayon, polyolefins, acrylics, superabsorbents, Lyocel regenerated cellulose and any other suitable synthetic fibers known to those skilled in the art. Synthetic fibers may also include kosmotropes for product degradation.

Natural fibers include wool, cotton, flax, hemp and wood pulp. Pulps include standard soft-wood fluffing grade such as CR-1654 from Coosa Mills of Coosa, Ala., high bulk additive formaldehyde free pulp (HBAFF) available from the Weyerhaeuser Corporation of Tacoma, Wash., and is a which is a crosslinked southern softwood pulp fiber with enhanced wet modulus, and a chemically cross-linked pulp fiber such as Weyerhaeuser NHB416. HBAFF has a chemical treatment which sets in a curl and twist, in addition to imparting added dry and wet stiffness and resilience to the fiber. Another suitable pulp is Buckeye HP2 pulp and still another is IP Supersoft from International Paper Corporation. Suitable rayon fibers are 1.5 denier Merge 18453 fibers from Courtaulds Fibers Incorporated of Axis, Ala.

Binders include fiber, liquid or other binder means which may be thermally activated. Exemplary binders include conjugate fibers of polyolefins and/or polyamides, and liquid adhesives. Two such suitable binders are sheath core conjugate fibers available from KoSA Inc. (formerly Trevira Inc. and formerly Hoechst-Celanese), PO Box 4, Salisbury, N.C. 28145-0004 under the designation T-255 and T-256, though many suitable binder fibers are known to those skilled in the art, and are made by many manufacturers such as Chisso and Fibervisions LLC of Wilmington, Del. A suitable liquid binder is Kymene® 557LX binder available from Fibervisions LLC.

Once produced and corrugated, the nonwoven web must be adequately stabilized and consolidated in order to retain its shape. The inclusion of a sufficient amount of fusible fibers and subsequent thermal bonding is the preferred method for obtaining adequate stabilization. Its believed that this method allows adequate bonding in the center of a thick material as well as on the surface. The inventors have found that such fusible fibers must be at least 40 percent and at most 100 percent of the fiber surface area of the web in order to result in a corrugated web with sufficient mechanical compression resistance.

The corrugated web must also have sufficient fold to fold attachment so that no gaps, channels or valleys exist between each fold in the corrugated web. When the corrugated web is used in an absorbent personal care product, this construction results in fluid necessarily entering the fibrous network of the web and being guided by the fiber surfaces and voids. A corrugated web with gaps or valleys, in contrast, allows fluid to move freely along the surface of the valley without entering the web. Allowing fluid to move freely along the surface can result in fluid leakage from the personal care product.

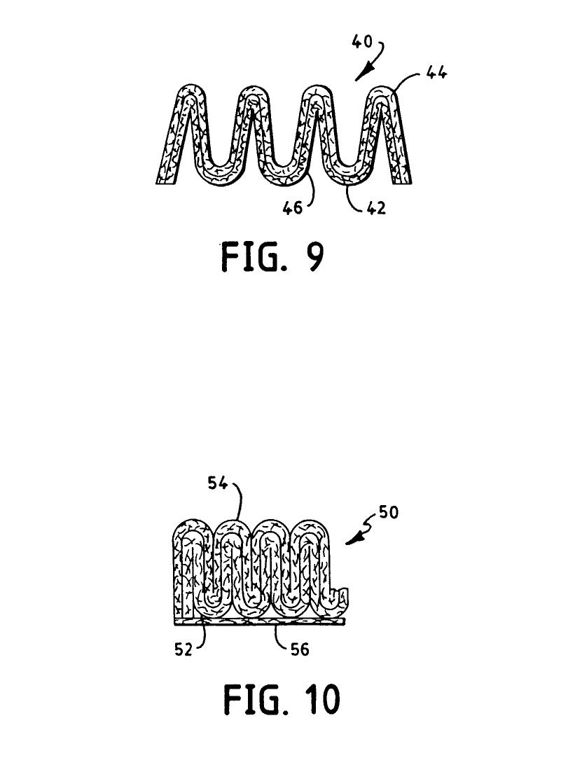

The degree of attachment between folds needed to eliminate gaps is best seen in FIGS. 9 and 10. FIG. 9 shows a typical corrugated web 40 where the folds 42, 44 are not attached and so allow the existence of gaps 46 therebetween. FIG. 10 shows a corrugated web 50 without gaps between the folds 52, 54. Note that though there is some void space between the fold peaks, there is no gap between the parallel parts of the folds. FIG. 10 further includes a layer of a fabric 56 bonded to the corrugated web 50 to form a laminate.

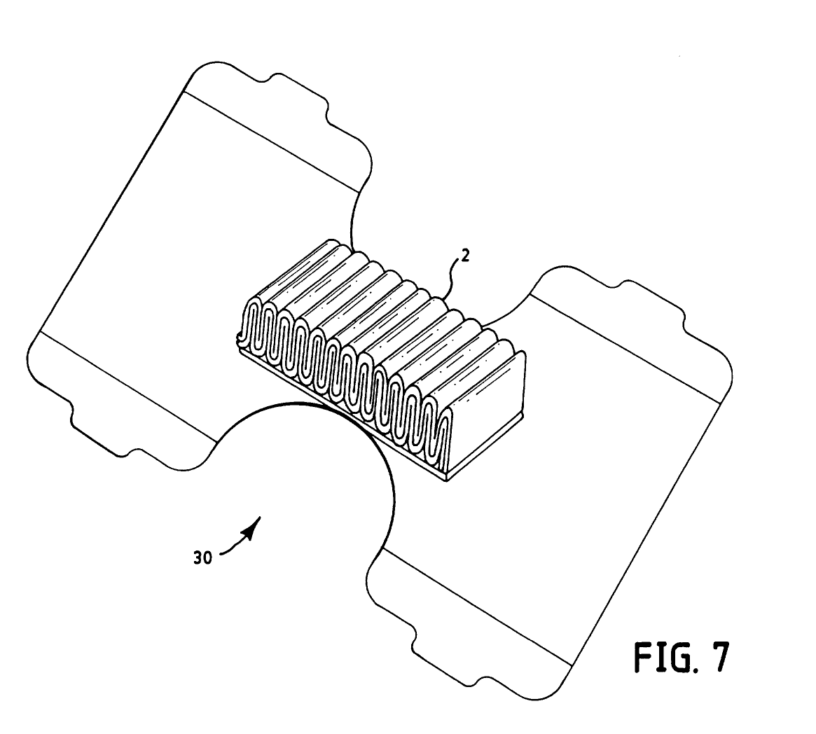

The inventors have also found that the desired fold to fold attachment results in improvements in the resistance to compressive forces. These resultant mechanical properties allow the maintenance of the needed absorbent void space while enhancing the material's directional fluid wicking properties. The greatest benefit of the corrugated web structure is surprisingly found when the corrugated web is placed in a personal care product in the transverse direction as shown in FIG. 7.

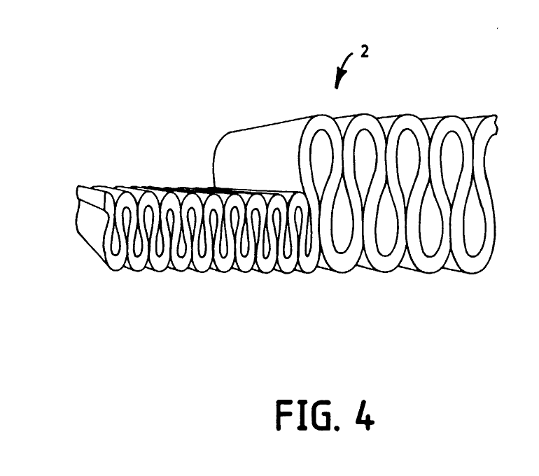

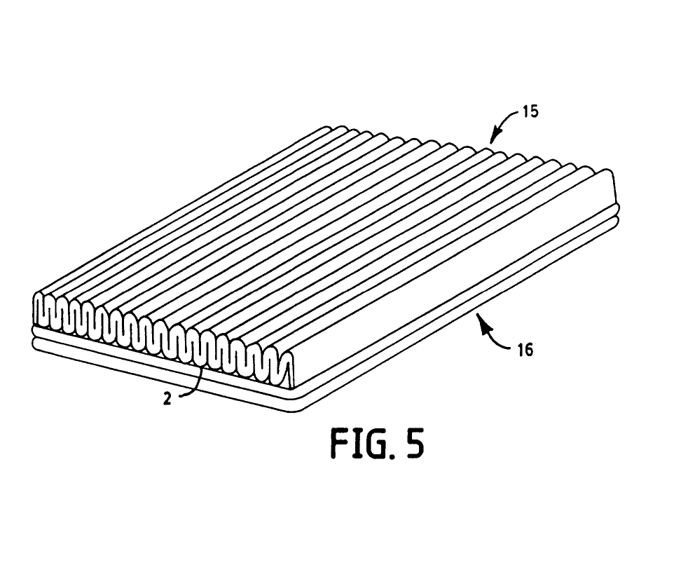

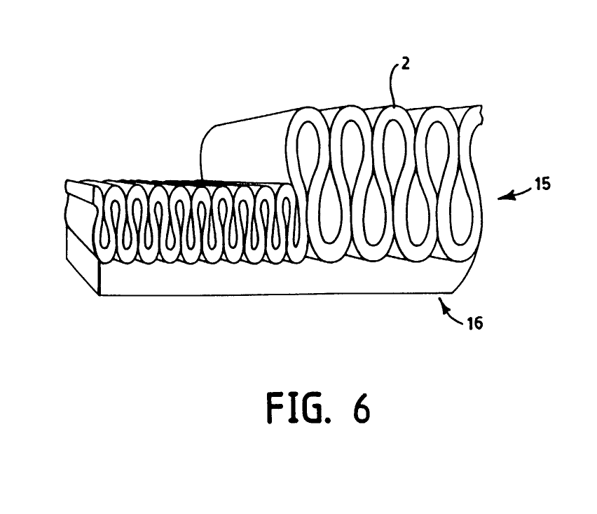

The corrugated web may have a uniform or non-uniform fold height or spacing required by the end use. FIG. 4 shows a web 2 with a non-uniform fold height. FIG. 6 shows a web 2 with non-uniform fold height which is laminated to another material 16 to produce a laminate 15.

In the case of a laminate, one or more materials may be corrugated together or a flat material can be corrugated separately and fused to it by, for example, thermal bonding and stabilization. Such other layers may be woven or knitted fabrics, other nonwovens, films, tissues, paper, foil, foam, etc., and each layer may contain a variety of fibers and particles to impart particular properties. In addition, a layer of nonwoven material (e.g. meltblown fibers) may be formed onto one or both sides of the corrugated web resulting in a sandwich-like construction.

A number of examples of different materials satisfying the objective of the invention were made and are described in detail below.

### EXAMPLES

The first and second webs (Examples 1 and 2) were made with 60 weight percent Type 233, 3 denier polypropylene, sheath/core conjugate (binder) fiber from Chisso Inc., also referred to as Chisso ES, and 40 weight percent Type 295 pentalobal polyester, 6 denier fiber from KoSa Inc. and processed for final basis weights of 85 and 112 gsm.

The third and fourth webs (Examples 3 and 4) were made from 60 weight percent Type 233, 3 denier polypropylene, sheath/core conjugate (binder) fiber from Chisso Inc., also referred to as Chisso ES, and 40 weight percent Type 295 pentalobal polyester, 6 denier fiber from KoSa Inc. and corrugated using a V600 vibrating perpendicular lapper available from Georgia Textile Machinery, Inc., of Dalton, Ga., and thermally stabilized by passing through a through-air bonder at 145° C.

A fifth web (Example 5) was made from 30 weight percent of Chisso ES Type 233 fiber, 40 weight percent 3 denier rayon, lot 2280 with a wettable soap finish from Courtaulds Fibers Incorporated of Axis, Ala., and 30 weight percent Type 295 pentalobal polyester, 6 denier fiber from KoSa Inc. This blend was also corrugated using the V600 vibrating perpendicular lapper from Georgia Textile Machinery.

The resulting corrugated fabrics had very low densities, e.g. usually less than 0.02 g/cc. This compares favorably to bonded carded web structures which generally have densities above 0.025 g/cc.

The results of the X-dimension and Z-dimension compression resistance testing according to the method given above and other properties are shown in the table below wherein the basis weight is given in grams per square meter (gsm), the thickness in inches (millimeters) and fusible fiber surface area is shown as a percent of all fibrous surface area present in the web.

| Fabric | 1 | 2 | 3 | 4 | 5 |
|---|---|---|---|---|---|
| Structure | Flat | Flat | Corrugated | Corrugated | Corrugated |
| Fusible Fiber Surface Area. | 72.3% | 72.3% | 72.3% | 72.3% | 38.4% |
| % | | | | | |
| Basis Wt (gsm) | 90.5 | 128.5 | 110.9 | 134.6 | 96.6 |
| Initial Thickness (mm) | 3.45 | 4.14 | 10.36 | 7.34 | 6.73 |
| Initial Density (g/cc) | 0.026 | 0.031 | 0.011 | 0.011 | 0.014 |
| X-Dimension Compression | | | | | |
| Compressive Toughness | 3.000 | 2.986 | 2.725 | 3.540 | 4.042 |
| Z-Dimension Compression | | | | | |
| Applied Load | Resultant Fabric Thickness (millimeters) | | | | |
| 0.05 psi | 3.454 | 4.140 | 10.363 | 7.341 | 6.731 |
| 1.0 psi | 0.940 | 1.372 | 1.194 | 2.388 | 0.660 |
| 2.0 psi | 0.610 | 0.914 | 0.762 | 1.372 | 0.406 |
| 3.0 psi | 0.483 | 0.711 | 0.584 | 0.991 | 0.279 |
| 2.0 psi | 0.533 | 0.787 | 0.660 | 1.092 | 0.330 |
| 1.0 psi | 0.686 | 0.991 | 0.813 | 1.346 | 0.457 |
| 0.05 psi | 2.692 | 3.302 | 5.004 | 5.486 | 3.277 |

As can be seen from these results, the structures of this invention have very high void volumes and good compression resistance. Comparing Samples 1-2 to Samples 3-4, it can be seen that under the same X-dimension force, the flat and corrugated materials at comparable basis weights demonstrate comparable levels of compressive toughness while the corrugated fabrics provide the added benefit of z-direction fiber surfaces to enhance fluid penetration into the structure. Likewise, the z-dimension compression results show that the after a cyclic load sequence, the corrugated structures maintain greater final fabric thickness and thus greater void volume for accommodating fluid. It should also be noted that Example 5 with reduced levels of fusible fiber surface area displays poorer compressive toughness due to the lack of internal structure fiber-to-fiber bonds as seen in Examples 3 and 4.

Such attributes lend themselves to incorporation into personal care products, which must absorb multiple liquid insults while under compression in more than one direction.

As can be seen from these results, the structures of this invention have very high void volumes and good compression resistance. Such attributes lend themselves to incorporation into personal care products, which must absorb multiple liquid insults while under compression in more than one direction.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims. In the claims, means plus function claims are intended to cover the structures described herein as performing the recited function and not only structural equivalents but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

It should further be noted that any patents, applications or publications referred to herein are incorporated by reference in their entirety.

What is claimed is:

1) A corrugated nonwoven web comprising a surface having a surface area, wherein at least 40 percent of said surface area is made from fusible fibers, and wherein said web is corrugated to produce folds and bonded such that no gaps are present between said folds.

2) The web of claim 1 wherein said web is made from a process selected from the group comprising spunbonding, meltblowing, airlaying, coforming and bonding and carding.

3) The web of claim 1 wherein said web comprises superabsorbent fibers.

4) The web of claim 1 wherein said folds are of uniform height.

5) The web of claim 1 wherein said folds are of non-uniform height.

6) The web of claim 1 wherein said web has been corrugated by a method selected from the group consisting of vertical lapping and rotary lapping.

7) A personal care product comprising the web of claim 1 wherein said web is aligned in said product in a transverse direction.

8) The personal care product of claim 7 which is a diaper.

9) The personal care product of claim 7 which is a training pant.

10) The personal care product of claim 7 which is an incontinence product.

11) The personal care product of claim 7 which is a bandage.

12) The personal care product of claim 7 which is a feminine hygiene product.

13) A laminate comprising a corrugated nonwoven web comprising a surface having a surface area, wherein at least 40 percent of said surface area is made from fusible fibers, and wherein said web is corrugated to produce folds and bonded such that no gaps are present between said folds, and at least one layer selected from the group consisting of nonwovens, wovens, knits, films, tissues, papers, foils and foams.

14) The laminate of claim 13 wherein said folds are of uniform height.

15) The laminate of claim 13 wherein said folds are of non-uniform height.

16) The laminate of claim 1 wherein said web comprises superabsorbent fibers.
